(19) United States
(12) Patent Application Publication
(10) Pub. No.: US 2021/0251144 A1
(43) Pub. Date: Aug. 19, 2021

(54) CROP HARVESTING BLADE SYSTEM

(71) Applicant: M & R RICKARDS PTY LTD, Ayr (AU)

(72) Inventor: Mark Edward Rickards, Ayr (AU)

(73) Assignee: M & R RICKARDS PTY LTD, Ayr (AU)

(21) Appl. No.: 17/176,618

(22) Filed: Feb. 16, 2021

(30) Foreign Application Priority Data
Feb. 18, 2020 (AU) 2020900453
Sep. 25, 2020 (AU) 2020239809

(51) Int. Cl. A01D 45/10; A01D 34/412

(52) U.S. Cl. CPC A01D 45/10; A01D 34/412

(57) ABSTRACT

A crop harvesting blade is provided for use in a mechanical crop harvesting machine to improve ratooning e.g. a chopper harvester for harvesting sugar cane. The crop harvesting blade has a plurality of rectangular teeth located at and uniformly arranged along the entire periphery of the blade body. The blade also has an attachment arrangement configured to provide a plurality of attachment positions for releasable attachment of the blade body to a base plate of a cutting portion of a mechanical crop harvesting machine. Upon attachment of the blade body to the base plate in each attachment position, the corresponding portion of the plurality of teeth is placed in an operative position.

### CROSS-REFERENCE TO RELATED APPLICATIONS

This application claims the right of priority to Australia Patent Application No. 2020239809 having a filing date of Sep. 25, 2020 and Australia Provisional Patent Application No. 2020900453 having a filing date of Feb. 18, 2020, the contents of each are herein incorporated by reference.

### FIELD OF THE INVENTION

The present invention relates to a blade and crop harvesting blade apparatus.

The invention has been developed primarily for use with mechanical crop harvesting machines such as mechanical sugar cane harvesting machines and will be described hereinafter with reference to this application. However, it will be appreciated that the invention is not limited to this particular field of use.

### BACKGROUND OF THE INVENTION

The global demand for sugar drives sugarcane agriculture. The physical properties of sugarcane present a challenge to harvesting the crop. Sugarcane has an elongate and slender shape, a hard outer shell and is fibrous throughout its width. The fibres are predominantly vertically aligned and there are multiple hard joints along the length of each sugar cane.

A sugarcane harvester is machinery that is typically used to harvest sugar cane. Typically, there are circular base plates on which rectangular blades are mounted. As sugarcane is typically vertically extending, the edges of the blades are oriented substantially horizontally relative to the longitudinal axis of the stalk of the sugarcane to cut the sugarcane across its width.

These base plates counter-rotate towards each other to draw in the sugar cane between the two base plates and to cut the sugarcane between the sets of the blades. It is preferable that the sugarcane be cut as close to the ground as possible to harvest most of the cane.

The plates are also angled relative to the ground so that the plates don't crush the remainder of the sugarcane plant or the remnant stool of the sugarcane as the machine moves forward during the harvesting process. Ratooning is the practice of cutting sugarcane above the ground in order to leave the roots of the sugarcane intact underground so that shoots for a new crop of sugarcane are produced from the same roots the next season.

This is important for ratooning so that the same roots can support new sugarcane growth. Also, as the sugarcane is cut as close to the ground as possible, the tips of the blades often contact soil and lose sharpness and cutting efficiency.

Therefore, the standard rectangular blades lose mass and are worn out relatively quickly. When blunt blades are used to cut sugarcane, there is a risk that the sugarcane will split or be otherwise, significantly damaged. As soon as sugarcane is cut, sugar loss starts occurring and if the cut cane is damaged, a significant amount of sugar leaches out, reducing the potency of the harvested cane.

Also, when blunt blades are used to cut sugarcane, the stool of the sugarcane tends to be damaged and so there is a lesser chance of a return crop or successful ratooning. Thus, blunt blades can result in large mechanical harvesting losses which can be very costly to farmers.

To prevent such losses blades must be sharpened regularly or replaced often which is a costly and inefficient exercise.

The present invention seeks to provide a sugar cane cutting blade system, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

In an aspect of the present disclosure, there is provided a crop harvesting blade comprising:
a blade body having a periphery;
a plurality of substantially rectangular teeth located at and uniformly arranged along the entire periphery of the blade body;
an attachment arrangement configured to provide a plurality of attachment positions for releasable attachment of the blade body to a base plate of a cutting portion of a mechanical crop harvesting machine,
   wherein each attachment position corresponds to a respective portion of the plurality of teeth, and
   wherein, in use, upon attachment of the blade body to the base plate in each attachment position, the corresponding portion of the plurality of teeth is placed in an operative position.

Each tooth may have a uniform width along substantially an entire length of the tooth.

Each tooth may have a width approximately equal to a width of a spacing between adjacent teeth.

Each tooth may have a width within the range of 4 mm to 10 mm.

Each blade may be circular. Each blade may have a circumference within the range of 200 mm to 250 mm.

Each blade may have a continuous periphery.

The attachment arrangement may comprise a ring of holes and a central hole located in the centre of the ring of holes which together define the plurality of attachment positions.

In the operative position the corresponding portion of the plurality of teeth may be in contact with unharvested crop, in use.

The mechanical crop harvesting machine may be a chopper harvester system for harvesting sugar cane.

In another aspect, there is provided, a crop harvesting blade apparatus comprising:
a plurality of the blades;
a base plate comprising a plurality of blade attachment portions, each blade attachment portion configured to enable attachment of each blade in any one of the attachment positions of the blade to position a respective portion of the teeth of the blade in the operative position, in use.

The blade attachment portion may comprise a plurality of holes configured to align with each of the plurality of attachment positions of each blade.

In yet another aspect, there is provided, a crop harvester comprising:
at least two feeding rollers adapted to counter-rotate towards each other, in use, and
two of the crop-harvesting blade apparatuses, each of the two crop harvesting blade apparatuses being attached to an end of a respective each of the feeding rollers.

One of the two crop harvesting blade apparatuses may be vertically offset from the other of the two crop harvesting blade apparatuses.

In yet another aspect of the present disclosure, there is provided a crop harvesting blade apparatus comprising:
a base plate;
a plurality of blades configured to be releasably mountable onto the base plate;
each blade of the plurality of blades comprising a plurality of teeth located at and uniformly arranged along a periphery of the blade.

The plurality of teeth may extend along the entire periphery of the blade.

Each tooth may have a uniform width along substantially the entire length of the tooth.

The length of each tooth may be within the range of 10 mm to 30 mm.

Each blade may have a uniform thickness.

Each blade may be substantially circular. In other embodiment, the blade may have an alternative shape such as a substantially rectangular shape or other polygonal shape.

Each blade may further comprise an attachment arrangement for attaching the blade to a base plate. The attachment arrangement may comprise a plurality of attachment positions for attaching to the base plate. Each attachment position may correspond to a portion of the blade. When the blade is attached to the base plate via one attachment position, a corresponding portion of the blade is placed in an operative position. The portion of the blade in the operative position may be in contact with unharvested crop, in use.

In an embodiment, the attachment arrangement may comprise a plurality of holes arranged in a ring and a central hole located in the centre of the ring. The central hole may be aligned with a centre of the blade.

The base plate may also comprise a plurality of blade attachment portions arranged around the periphery of the plate configured to attach to a blade at an attachment position. Each blade attachment portion may have a first side edge, a second side edge and a top edge.

There may be recesses defined between adjacent plate portions to minimise contact of the base plate with unharvested crop, in use.

In another aspect, there is provided a crop harvesting blade system comprising:
a base plate comprising at least one blade attachment portion;
at least one blade comprising an attachment arrangement configured to provide a plurality of attachment positions for releasable attachment of the blade to the blade attachment portion, each attachment position corresponding to a portion of the blade,
wherein in each attachment position, the corresponding portion of the blade is placed in an operative position.

Each blade attachment portion may comprise a plurality of holes.

The attachment arrangement may comprise a ring of holes and a central hole located in the centre of the ring of holes which define the one or more attachment positions.

The blade attachment portion may comprise a plurality of holes configured to align with holes of the one or more attachment positions on each blade.

Each blade may be constructed by laser cutting.

The base plate may be constructed via laser cutting.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a bottom view of the crop harvesting blade apparatus in accordance with an embodiment of the present invention;

FIG. 2 illustrates a blade of the crop harvesting blade apparatus in accordance with the embodiment of FIG. 1;

FIG. 3 is a top view of the crop harvesting blade apparatus shown in FIG. 1;

FIG. 4 is a side view of the crop harvesting blade apparatus shown in FIG. 1;

FIG. 5 is a perspective view of the crop harvesting blade apparatus in accordance with the embodiment shown in FIG. 1, when attached to a mechanical sugar cane harvesting machine.

### DESCRIPTION OF EMBODIMENTS

It should be noted in the following description that like or the same reference numerals in different embodiments denote the same or similar features.

Embodiments of a crop harvesting blade 100, crop harvesting blade apparatus 1000 and crop harvesting blade system will now be described in relation to the harvesting of sugar cane using a mechanical sugar cane harvesting machine. However, it is envisaged that the crop harvesting blade 100, crop harvesting blade apparatus 1000 and crop harvesting blade system can be used to harvest a variety of different types of crops such as crops of similar mechanical characteristics to sugar cane or crops with mechanical characteristics not similar to sugar cane.

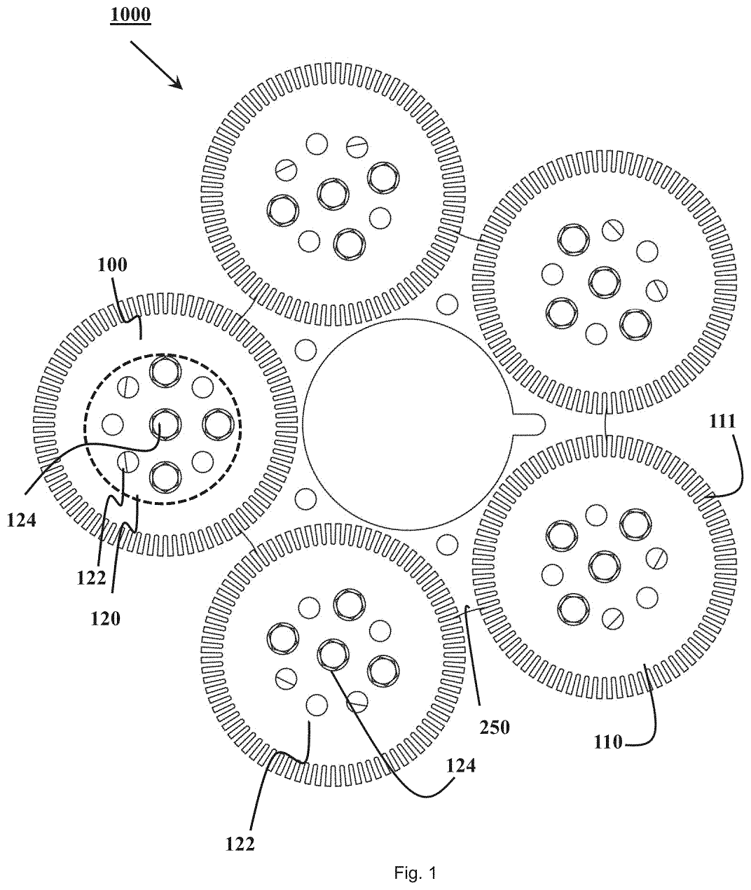

A crop harvesting blade apparatus according to an aspect of the invention is generally indicated by the numeral 1000. As shown in FIGS. 1 to 5, the crop harvesting blade apparatus includes a base plate 200 and a plurality of blades 100 that are each configured to be mounted on the base plate 200. Each blade 100 of the plurality of blades comprises a plurality of teeth 111 located at and uniformly arranged along the periphery 110 of the blade.

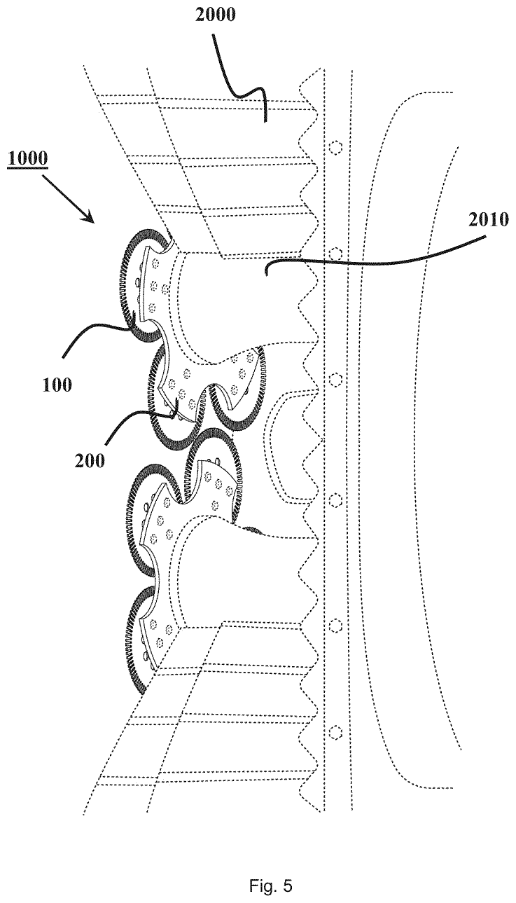

In the illustrated embodiment, the base plate 200 of the crop harvesting blade apparatus 1000 is configured to be mounted to a mechanical sugar cane harvesting machine. In the illustrated embodiment, the mechanical sugar cane harvesting machine is a chopper harvester system an example of which is partially shown in FIG. 5. The chopper harvester system 2000 includes a base cutter. The crop harvesting blade apparatus 1000 is configured to be used as part of the base cutter of the chopper harvester system 2000.

It is envisaged that in some embodiments, the base plate 200 can be configured in a number of different ways to attach to various mechanical sugar cane harvesting machines.

In the illustrated embodiment each blade 100 is substantially planar and circular in shape. The circular shape of the blade makes the blade more resistant to damage during use than other shapes such as a rectangular shape. The Applicant has found that the circular shape of the blade results in a slicing action when used as part of the apparatus during operation of the mechanical cane harvesting machine. This slicing action also reduces impact force on the sugar cane plant during harvesting i.e. the circular blade does not act as an axe. In contrast, conventional blades that are rectangular in shape typically have a flat knife-edge at a periphery of the blade and therefore, behave like axes when attached to a rotating base plate. Therefore, using the present blade, by creating a clean slice through the stem of sugarcane during harvesting results in less damage to the crop. This, in turn, results in a more vigorous ratoon than would be achieved using conventional rectangular blades. It is envisaged that in other embodiments, the shape of each blade can be a polygon with 5 or more sides.

Each blade has a uniform thickness. In the illustrated embodiment, the thickness of each blade is approximately 3 mm. In other embodiments, the thickness of the blade can be within the range 2 mm to 10 mm.

As mentioned above, the blade is substantially circular and so, the periphery or edge of each blade 100 is also substantially circular. The blade can have a circumference between approximately 200 mm to approximately 250 mm. For example the circumference of the blade can be approximately 210 mm, 220 mm, 230 mm or 240 mm.

In the illustrated embodiment, the plurality of teeth 111 is arranged along the entire periphery 110 of each blade 100. As explained in further detail below, this allows the entire periphery 110 of the blade to be utilised before replacement of the blade is necessary.

The plurality of teeth on each blade 100 is uniform in size and shape. Each tooth is substantially rectangular i.e. each tooth has a uniform width along substantially the entire length the tooth. In another embodiment, each tooth may be substantially square.

In the illustrated embodiment, the approximate width of each tooth is 5 mm. It is envisaged that in other embodiments the width of each tooth can be within the range 2 mm to 7 mm or within the range of 4 mm to 10 mm. For example, the width of each tooth can be approximately 3 mm or 4 mm or 6 mm or 7 mm or 8 mm or 9 mm.

In the illustrated embodiment, the length of the tooth is approximate 15 mm. In other embodiments, the length of each tooth can be within the range of 10 mm to 30 mm. For example, the length of each tooth can be 15 mm or 17 mm or 20 mm or 25 mm or 27 mm or 30 mm.

The plurality of teeth 111 is also uniformly arranged along the periphery of the blade 110 i.e. adjacent teeth are equally spaced apart from each other. In the illustrated embodiment, the approximate spacing between adjacent teeth is 5 mm. The width of the tooth is equal to the width of the gap between adjacent teeth. It is envisaged that in other embodiments the space between each tooth can be within the range 2 mm to 7 mm.

The applicant has found that the shape and arrangement of teeth on each blade reduces impact force on the sugar cane plant during harvesting and in turn, enhances the quality and quantity of the ratoon crop after harvesting.

The skilled person will appreciate that the dimensions of each blade 100 and the ratio of the length of each tooth to the diameter of the blade 100, for example, can be varied. In other embodiments, the shape and width of the teeth can be varied.

It is envisaged that in other embodiments, each blade 100 can be suitably configured to attach to existing base plates (not shown) of mechanical sugar cane harvesters such as those known as chopper sugar cane harvesters. Advantageously, the blades can be retrofitted to existing base plates of the base cutters of chopper style sugar cane harvesters.

In the illustrated embodiment, each blade 100 has an attachment arrangement 120 for attaching to the base plate 200 shown in the figures. As can be seen in for example, FIG. 1, the attachment arrangement 120 comprises an arrangement of a plurality of holes via which each blade 100 can be attached to the base plate.

Each hole extends through the entire thickness of the blade. In the illustrated embodiment, each hole has the same diameter.

In the illustrated embodiment, the arrangement of the plurality of holes is in the shape of a circle i.e. the holes are arranged in a ring 122 around a central hole 124. The central hole 124 is located at the centre of the blade.

The ring of holes 122 is concentric with the blade i.e. the centre of each hole in the ring of holes 122 is at the same radial distance from the centre of the central hole.

In this embodiment, the ring of holes 122 has 8 holes such that each hole on one side of the central hole has an opposed hole. It is envisaged that in other embodiments, the ring of holes can have more than 8 holes or less than 8 holes.

The 8 holes are uniformly arranged such that the centre of each hole of the ring 122 is colinear with the centre of the central hole 124 as well as the centre of an opposed hole that is also in line with the central hole. In other words, the holes are arranged such that a straight line drawn from the centre of one hole to the centre of an opposed hole will also intersect the centre of the central hole.

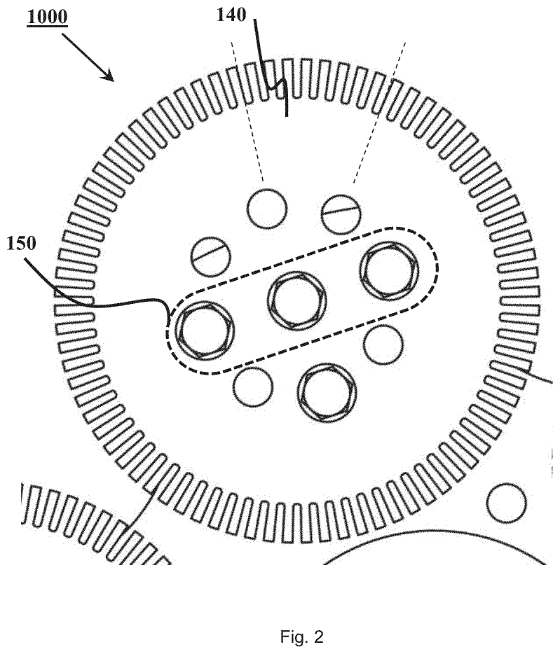

As explained in detail below, in the illustrated embodiment, the attachment arrangement of each blade 100 is configured to provide 8 different attachment positions or 8 arrays of three holes 150, for attachment of the blade to the base plate 200. Each of the 8 arrays corresponds to a different portion 140 of the blade as indicated in FIG. 2, each of which can be oriented into an operative position. FIG. 2 shows one of the 8 arrays of three holes 150 within dotted lines.

The base plate 200 is substantially planar and has a uniform thickness. In the illustrated embodiment, the base plate 200 has a thickness of approximately 12 mm. In other embodiments, the base plate can have a thickness within the range of 10 mm to 20 mm.

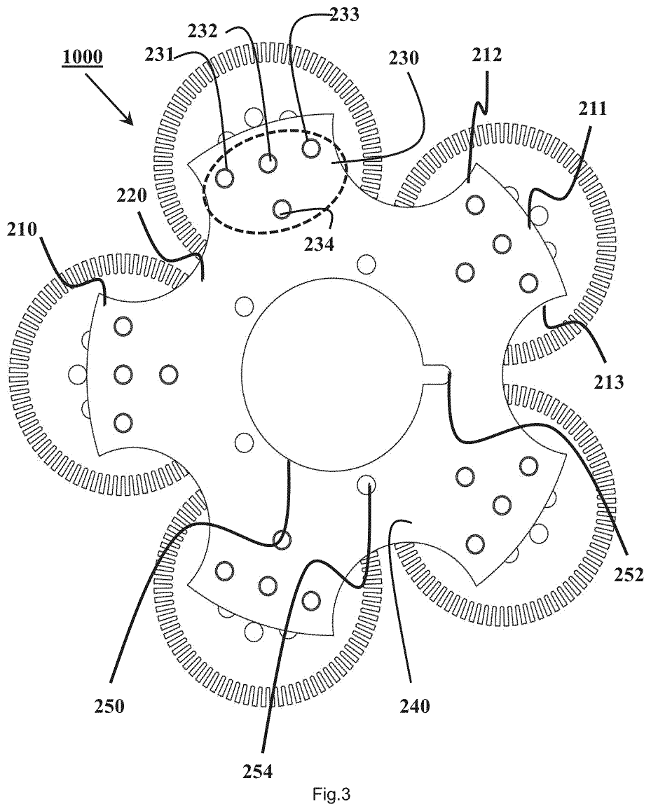

As shown in FIG. 3, the base plate 200 comprises a plurality of blade attachment portions 210 uniformly arranged around the periphery of the base plate 200. A circular recess 220 or inwardly facing “scallop” is located between adjacent blade attachment portions such that each blade attachment 210 portion protrudes radially outwards relative to the recesses 220.

In this way the base plate 200 is configured to minimise contact of parts of the base plate 200 between blade attachment portions 210, with unharvested crop, in use. As a result, each blade attachment portion 210 has an outermost edge 211 extending from a first end to a second end. Each blade attachment portion 210 also has a first side 212 and an opposed second side 213, each side extending inwardly from the outermost edge. Each side is also curved and part of an inwardly facing recess 220.

In the illustrated embodiment the base plate 200 has five blade attachment portions 210 for attaching to five blades 100 and five recesses 220. However, it is envisaged that in other embodiments, the base plate 200 can have more than or less than five blade attachment portions 210 and five recesses 220.

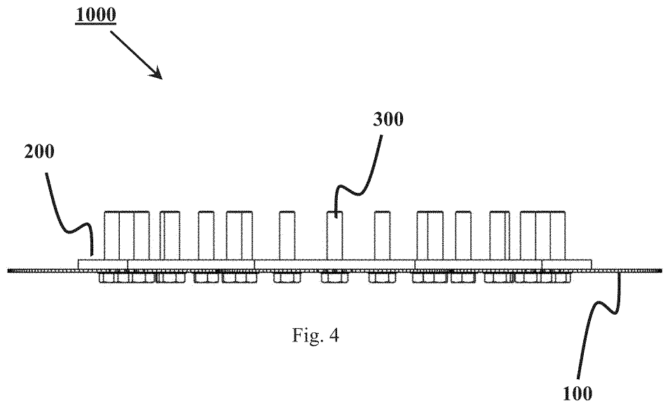

In the illustrated embodiment, each blade attachment portion 210 comprises a plurality of holes 230 via which the base plate 200 can be attached to a blade 100 using a fastening arrangement e.g. a nut and bolt arrangement. FIG. 4 shows a side view of the apparatus 1000 when each blade 100 is engaged with each corresponding blade attachment portion 210 of the base plate 200 using bolts 300. Preferably, these bolts will have a short length of thread with a low profile hex head so as not to protrude above the plate 200 and restrict flow of cane into a throat of the machine, and the bolts will also have limited protrusion below the plate so as not to damage the remnant cane stool.

In another embodiment, each blade attachment portion (not shown) can comprise a plurality of pins (not shown) extending perpendicularly to the blade attachment portion for insertion into some of the plurality of holes in the attachment portion of a blade 100. The blade 100 can then be secured to the base plate with a fastener.

In the illustrated embodiment, the arrangement of the plurality of holes of the base plate 200 is located adjacent the top edge 211 of each blade attachment portion 210 such that when the blade 100 is attached to the blade attachment portion 210, part of each blade 100 protrudes sufficiently outwardly from the blade attachment portion 210.

The arrangement of holes in each blade attachment portion 210 is configured such that the blade 100 is secured to the blade attachment portion 210 and does not detach from the base plate 200 in use. Therefore, the attachment between each blade 100 and each blade attachment portion 210 must be sufficiently mechanically robust to transfer forces from the base plate 200 to the blade 100 and to transfer any mechanical forces encountered by the blade 100 to the base plate 200 during extended operation of the mechanical sugar cane harvesting machine.

As shown in FIG. 3, for example, the arrangement of holes in each blade attachment portion 210 of the base plate 200 comprises three corresponding holes that are uniformly and linearly arranged across each blade attachment portion between the two sides of each blade attachment portion.

The three holes are configured to correspond with and in particular, align with any one of the 8 arrays of three holes within the attachment arrangement of each blade 100 when each blade 100 is positioned on and is in face to face contact with a blade attachment portion 210. For example, as shown in FIG. 3, the first hole 231, second hole 232 and third hole 233 of the attachment portion 210 correspond to one of the 8 arrays of three holes of the blade 100 (shown by reference numeral 150 in FIG. 2). As can be seen in FIGS. 1 and 3, the second corresponding hole 232 corresponds to the central hole 124 of the arrangement of the plurality of holes of the attachment arrangement 120.

A fourth hole 234 is located under the second hole 232. The centre of each of the first 231, third 233 and fourth 234 corresponding holes are at the same radial distance from the centre of the second hole 232 as each of the holes in the ring 122 are from the central hole 124 of the arrangement of the plurality of holes of each blade 100.

To attach a blade 100 to the base 200, the blade 100 is placed in face to face contact with a blade attachment portion 210. The blade 100 is moved relative to each blade attachment portion 210 such that the three corresponding holes 150 are aligned with and overlap with any one of the 8 arrays of three holes of the attachment arrangement 120 of the blade 100.

As can be seen in FIGS. 1, 2 and 3, when the three corresponding holes of the base plate are aligned with any one of the 8 arrays of three holes of the attachment arrangement 120, the fourth hole is also aligned with a hole in the ring 122. Fastening arrangements such as a bolt and nut arrangement can be used to secure each blade 100 to each blade attachment portion 210 on the base plate 200. In the present embodiment, each of the holes within the blade and the base plate are threaded. In this case, a nut is not required to fasten each blade 100 to each blade attachment portion 210.

A crop harvesting blade system is also provided by the crop harvesting blade apparatus 1000. As mentioned above, in the illustrated embodiment the attachment arrangement 120 of each blade 100 is configured to provide 8 different attachment positions such as at 150 for attachment of the blade 100 to the base plate 200. Each of the 8 different attachment positions correspond to 8 different portions of the blade 100, each of which can be placed into an operative position when the blade is attached to the blade attachment portion 210 in the corresponding attachment position.

Given that each blade 100 is circular, each portion of the blade 100 corresponds to a sector of the blade 100. The teeth of that sector of the blade 100 is most likely be in repeated contact with unharvested sugar cane, in use, and will therefore, be in the operative position.

The applicant has found that the portion of the blade 100 in the operative position has the highest amount of contact with unharvested crop during operation. In other words, the portion of the blade 100 in the operative position is utilized more than other parts of the blade 100 during operation. Therefore, this portion of the blade 100 is also susceptible to experiencing the greatest amount of wear during use.

As mentioned above, FIG. 2 shows one of the 8 arrays of three holes 150 within dotted lines. FIG. 2 also shows a corresponding portion 140 of the blade relating to the array of three holes indicated by the reference numeral 150. The applicant has found, based on the extent of wear for the particular base plate 200, shape, size configuration of the blade 100 that to utilize all portions of each blade 100, the blade 100 can be divided into 8 sectors. Therefore, the attachment arrangement 120 of each blade 100 is configured to enable each of the 8 sectors/portions to be placed into the operative position for maximum utilization of the blade 100 before replacement of the blade is necessary.

For example, initially, each blade 100 can be attached to each blade attachment portion 210 of the base plate 200 as described above in one of the 8 attachment positions to place one of the portions of each blade 100 in the operative position.

When the portion of the blade e.g. as indicated by reference numeral 140 in the operative position is worn due to use and no longer useful, a user can detach each blade 100 from the base plate 200 by for example, undoing the fasteners. The user can then rotate the attachment arrangement 120 of each blade 100 relative to the holes of each blade attachment portion 210 to orient the blade 100 into another attachment position to place an unused portion the blade into the operative position. In the illustrated embodiment, when one attachment position is used and the corresponding portion of the blade is in the operative position, 7 other similarly sized portions are unused. Therefore, each blade can be rotated into 7 more attachments positions each corresponding to an unused portion of the blade before the blade 100 needs to be replaced.

Advantageously, this crop harvesting blade system remains efficient throughout the harvesting process as the teeth 111 wear to a shorter length without otherwise distorting their rectangular shape and cutting efficacy. Furthermore, each blade can be used in eight positions, therefore lasting for a longer period of time than a conventional blade before a replacement is needed.

The applicant has found that, in use, rectangular shaped teeth 111 are more resistant to wear and have sustained cutting efficacy when compared to conventional rectangular blades. Further, the applicant has found that the teeth 111 of the portion of the blade 100 in the operative position is bevelled during use which results in a sharpening effect. Advantageously, this further improves cutting efficiency.

The applicant has also found that using the present blades 100 and the crop harvesting blade apparatus 1000, a relatively lower operational hydraulic pressure (PSI) is required from the cane harvesting machine to achieve the rotational speed necessary to harvest the sugar cane whilst achieving an improved quality of severance of crop over conventional blades. Therefore, the mechanical sugar cane harvesting machine does not need to operate at a higher level to achieve the same quality of severance of crop as using conventional blades. This will allow the machine to have a longer useful life and reduce operational costs.

Advantageously, due to the shape of the blade in the illustrated embodiments, the angle at which the apparatus is angled during use can be reduced. In this way, there is less chance of the blade contacting the ground and therefore, wearing due to rubbing against soil in use. Less soil is also fed into the cane harvesting machine during the harvesting operation, in use. This further contributes to the longevity of the machinery as soil can be very abrasive.

Furthermore, a reduction in soil contamination when milling sugar cane to produce sugar crystals is beneficial for both miller and farmer as the mill operates more efficiently when there is less dirt contamination in delivered sugar cane which is desirable.

The applicant has also found that due to the cutting efficacy of the harvester blade apparatus 1000, the harvester can operate at an increased forward speed without creating damage to the cane stool as would be expected when utilising the conventional blade configuration. This leads to better harvesting efficiencies for the harvesting operator as machine hours are reduced.

FIG. 4 shows two of the crop harvesting blade apparatus 1000 as attached to feeding rollers of a mechanical sugar cane harvesting machine. The two feeding rollers comprise legs oriented vertically, in use, that counter-rotate towards each other.

As a result, base plates 200 and blades 100 also counter-rotate towards each other. As shown in FIG. 4, the base plates 200 and blades 100 are positioned relative to each other such that the blades 100 are close to each other but do not overlap or interfere with each other during use. One of the two crop harvesting blade apparatuses is also slightly vertically offset from the other such that the blades 100 of one crop harvesting blade apparatus does not overlap with the blades 100 of the other. As the vertical legs rotate, the portions of the blades 100 in the operative position cut the unharvested sugar cane. The counter-rotating motion draws or feeds in the uncut cane between the two blade arrangements and also moves the cut cane into a collector (not shown) positioned behind the feeding rollers, in use.

The base plate 200 is constructed from a steel plate of requisite thickness. In particular, a steel plate 200 can be laser cut into a circular shape. The recesses 220 can then be cut out of the circular shaped steel plate to define the blade attachment portions 210. Holes in the base plate 200 can be formed using known methods such as drilling and tapping. The base plate 200 is made of quenched and tempered steel. In other embodiments, the base plate 200 can be made of other durable metals such as treated steel.

Each blade 100 is also constructed by laser cutting a metal sheet of requisite thickness. Each of the blades 100 are also made of 80 CRV 2 carbon spring steel. The blades 100 can also be made of other types of steel such as steel that is typically used for making knives or industrial blades or other tools.

It is envisaged that the base plate 200 can be configured in a number of different ways to attach to various types of chopper harvesting machines.

In this embodiment, the base plate has a centrally located circular cutout 250 contiguous with an oval shaped slot 252. This cutout 250 is surrounded by a plurality of holes 254. The centrally located cutout 250 is configured to fit around a similarly shaped cross section of one of the legs 2010.

In this example, each leg 2010 of the harvesting machine has a circular foot (not shown) located under each leg 2010 which retains the base plate 200 on each leg 2010.

At the bottom of each leg 2010 is a cylindrical foot (not shown) that has a radius of approximately 140 mm (not shown). From the outer edge of the foot to 40 mm inward is a rebated ring of approximately 10 mm depth (not shown) thus leaving a remaining central diameter of approximately 200 mm around which the cutout 250 of the base plate 200 is configured to fit. The 40 mm rebated section (not shown) has threaded portions extending vertically from the rebated section corresponding to the four holes 254 and one slot hole 252 of the base plate 200. The base plate 200 can then be bolted to the rebated section using suitably sized bolts.

### Interpretation

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

As used herein the term “and/or” means “and” or “or”, or both.

As used herein “(s)” following a noun means the plural and/or singular forms of the noun.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as falling? within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the agricultural industries.

What is claimed is:

1. A crop harvesting blade comprising:
a blade body having a periphery;
a plurality of substantially rectangular teeth located at and uniformly arranged along the entire periphery of the blade body;
an attachment arrangement configured to provide a plurality of attachment positions for releasable attachment of the blade body to a base plate of a cutting portion of a mechanical crop harvesting machine,
wherein each attachment position corresponds to a respective portion of the plurality of teeth, and
wherein, in use, upon attachment of the blade body to the base plate in each attachment position, the corresponding portion of the plurality of teeth is placed in an operative position.

2. The crop harvesting blade of claim 1, wherein each tooth has a uniform width along substantially an entire length of the tooth.

3. The crop harvesting blade of claim 1, wherein each tooth has a width approximately equal to a width of a spacing between adjacent teeth.

4. The crop harvesting blade of claim 1, wherein each tooth has a width within the range of 4 mm to 10 mm.

5. The crop harvesting blade of claim 1, wherein each blade is circular and has a circumference within the range of 200 mm to 250 mm.

6. The crop harvesting blade of claim 1, wherein each blade has a continuous periphery.

7. The crop harvesting blade of claim 1, wherein the attachment arrangement comprises a ring of holes and a central hole located in the centre of the ring of holes which together define the plurality of attachment positions.

8. The crop harvesting blade system of claim 1, wherein in the operative position the corresponding portion of the plurality of teeth will be in contact with unharvested crop, in use.

9. The crop harvesting blade system of claim 1, wherein the mechanical crop harvesting machine is a chopper harvester system for harvesting sugar cane.

10. A crop harvesting blade apparatus comprising:
a plurality of blades in accordance with claim 1;
a base plate comprising a plurality of blade attachment portions, each blade attachment portion configured to enable attachment of each blade in any one of the attachment positions of the blade to position a respective portion of the teeth of the blade in the operative position, in use.

11. The crop harvesting blade apparatus of claim 10, wherein the blade attachment portion comprises a plurality of holes configured to align with each of the plurality of attachment positions of each blade.

12. A crop harvester comprising:
at least two feeding rollers adapted to counter-rotate towards each other, in use, and
two crop harvesting blade apparatuses in accordance with claim 1, each of the two crop harvesting blade apparatuses being attached to an end of a respective each of the feeding rollers.

13. The crop harvester of claim 12 wherein one of the two crop harvesting blade apparatuses is vertically offset from the other of the two crop harvesting blade apparatuses, in use.
